(19) United States
(12) Patent Application Publication
(10) Pub. No.: US 2004/0008093 A1
(43) Pub. Date: Jan. 15, 2004

(54) Compact non-reciprocal circuit element

(75) Inventors: Eiichi Komai, Niigata-ken (JP); Hitoshi Onishi, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/618,375

(22) Filed: Jul. 9, 2003

(30) Foreign Application Priority Data
Jul. 12, 2002 (JP) 2002-204612

(51) Int. Cl. H01P 1/36

(52) U.S. Cl. 333/1.1; 333/24.2

(57) ABSTRACT

A non-reciprocal circuit element has a yoke including a top yoke component and a bottom yoke component. The yoke includes a magnetic plate, line conductors, capacitor chips disposed around the magnetic plate, and a magnet for applying a bias magnetic field. The line conductors intersect on the main surface of the magnetic plate. Each end of the line conductors is connected to the corresponding capacitor chip. The magnet has a major axis and a minor axis, and further has a convex surface on at least one peripheral portion thereof.

### BACKGROUND OF THE INVENTION

1. Field of the Invention

The present invention relates to non-reciprocal circuit elements, such as isolators and circulators, used in high-frequency bands such as the microwave band.

2. Description of the Related Art

FIG. 7 is an exploded perspective view of a typical conventional isolator (non-reciprocal circuit element) 60 that includes a bottom yoke component 61 and a top yoke component 62. The isolator 60 further includes a magnet 63, a spacer 64, a magnetic assembly 65, three capacitor chips 66, 67, and 68, a terminator (resistor) 69, and a board 70 which are disposed between the bottom yoke component 61 and the top yoke component 62.

The magnetic assembly 65 includes a disk-shaped magnetic plate 72 which may be composed of ferrite, three central conductors 73, 74, and 75 covering the upper surface of the magnetic plate 72, and a common electrode (not shown in FIG. 7) which connects to the conductors 73, 74, and 75 on the lower surface of the magnetic plate 72. Each of the conductors 73, 74, and 75 is divided by a slit which extends along its longitudinal direction.

The thin capacitor chips 66, 67, and 68 are disposed on the board 70 such that they together encircle the magnetic assembly 65. The central conductors 73, 74, and 75 of the magnetic assembly 65 have respective end strips 73a, 74a, and 75a bonded to the capacitor chips 66, 67, and 68 lying therebelow by, for example, soldering. The plate spacer 64, which has projections 64a, is disposed on the magnetic assembly 65. The plate magnet 63 is disposed on the spacer 64.

The magnet 63 provided in this conventional isolator 60 shown in FIG. 7 applies a perpendicular bias magnetic field to the magnetic plate 72. In order to form part of the magnetic path of the bias magnetic field applied from the magnet 63, the bottom yoke component 61 and the top yoke component 62 each have two vertically bent sides to form a box by fitting these sides to each other.

Isolators are becoming smaller every year. Accordingly, the yoke consisting of the bottom yoke component 61 and the top yoke component 62 should be made as small as possible. In viewing this, the magnet 63, the spacer 64, and the magnetic assembly 65 accommodated in the yoke should preferably be compact.

Unfortunately, compact design of the magnet 63 is not simple because, for example, the magnet 63 must apply a uniform and distortion-free bias magnetic field to the magnetic plate 72 of the magnetic assembly 65 in the vertical direction (defined as the thickness direction of the magnetic plate 72). In other words, compact design of the magnet 63 may lead to poor uniformity of the bias magnetic field applied to the magnetic plate 72, adversely affecting the performance of the isolator 60, such as increasing the insertion loss.

In order to avoid such poor uniformity of the bias magnetic field, the magnetic plate 72 in the conventional design is manufactured smaller than the magnet 63 so that the entire magnetic plate 72 is covered by the uniform vertical magnetic field.

Thus, the size of the conventional magnetic plate 72 is generally set to about 50% of the entire width of the isolator 60. In order to enhance the performance of the isolator 60, however, the magnetic plate 72 should desirably be as large as possible, although the entire isolator 60 is recently designed to be more compact.

It is also known that the magnet 63 in the conventional isolator 60 shown in FIG. 7 may be rectangular instead of circular.

Nonetheless, a circular disk magnet is more popular in the conventional isolator. This is because such a circular magnet has no angular edges causing a distorted magnetic field and is thus advantageous in the control of the bias magnetic field applied to the magnetic assembly. On the other hand, a rectangular magnet causes a problem in that the bias magnetic field to be applied to the magnetic plate is likely to suffer from distortion at the four corners thereof. If the isolator is large enough to allow the magnetic plate to be sufficiently smaller than the magnet, distortion of the bias magnetic field involved with this rectangular magnet is negligible. In fact, even if the isolator is more compact, for example, having dimensions of 4 mm by 4 mm or less, in accordance with the recent demands for compact design, the magnetic plate itself cannot be designed smaller than expected in order to maintain the performance of the isolator. Consequently, the size of the magnet inevitably becomes closer to that of the magnetic plate. In this case, distortion of the magnetic field occurring in the four corners of the rectangular magnet measurably affects the edge of the magnetic assembly.

As described above, a circular magnet is advantageous in applying a uniform bias magnetic field to the magnetic assembly. In an isolator designed to be more compact, however, it is difficult to allot a space for holding other components, such as the capacitor chips, around this circular magnet, and therefore the circular magnet in the yoke consisting of the bottom yoke component 61 and the top yoke component 62 is not space-efficient.

### SUMMARY OF THE INVENTION

Accordingly, it is an object of the present invention to provide a high-performance, compact, and easily manufacturable non-reciprocal circuit element including a magnet with a special shape.

In order to achieve the object described above, a non-reciprocal circuit element according to the present invention includes a yoke, which further includes a magnetic plate; a plurality of line conductors which are disposed on a main surface of the magnetic plate and insulated from one another; a plurality of capacitor chips disposed around the magnetic plate; and a magnet for applying a DC bias magnetic field in a direction substantially perpendicular to the main surface of the magnetic plate. The line conductors intersect on the main surface of the magnetic plate and are connected to one another on the other surface of the magnetic plate, the terminal segments of the intersecting line conductors are connected to the capacitor chips, and the magnet has a major axis and a minor axis in plan view and a convex surface on at least one peripheral portion thereof.

The magnet, which has a major axis and a minor axis in plan view and a convex surface on at least one peripheral portion thereof, is capable of applying a low-distortion and intensity-efficient bias magnetic field to the magnetic plate compared with magnets of other shapes, such as a rectangle, thus contributing to compact design of the non-reciprocal circuit element. In addition, the magnet with a major axis and a minor axis features a smaller footprint than a circular magnet and allows flat layout of components, unlike a circular magnet in which other components such as capacitor chips are arranged around the magnet, thus contributing to compact design of the non-reciprocal circuit element.

The magnet may have a plan-view shape generated by partially truncating a circle or an ellipse along a straight line.

The magnet of the foregoing plan-view shape is capable of applying an intensity-efficient bias magnetic field to the magnetic plate, compared with a magnet with the same thickness but a different shape, such as a rectangle, thus contributing to compact design of the non-reciprocal circuit element. The magnet of the foregoing shape also facilitates processing during manufacturing because it requires cutting of two sides only, whereas a magnet of another shape, such as a rectangular magnet, requires cutting of four sides. The magnet of the foregoing shape is also space-efficient because it can apply an intense bias magnetic field despite its smaller footprint, in the yoke, than a circular magnet.

The magnet may have a plan-view shape like an ellipse or a racing track. Furthermore, the projection plane of the magnetic plate may have a shape identical to or completely covered by the shape of the projection plane of the magnet.

A magnet of these shapes is easier to manufacture and allows a more uniform and more intense bias magnetic field to be applied to the magnetic plate than a magnet of other shapes, such as a rectangle, with the same area and thickness.

The ratio of the minor (or major) axis of the magnet to the minor (or major) axis of the magnetic plate may range from 1.0 to 1.9.

The ratio of the manor (or major) axis of the magnet to the minor (or major) axis of the magnetic plate may range from 1.6 to 1.9.

Within the above ranges, the magnet is capable of efficiently applying an intense bias magnetic field to the magnetic plate.

### BRIEF DESCRIPTION OF THE DRAWINGS

FIG. 1A is an internal plan view of an isolator according to an embodiment of the present invention;

FIG. 1B is a partial sectional view of the same isolator shown in FIG. 1B;

FIG. 2 is a plan view showing an example of a magnetic plate and a magnet used in an isolator according to an embodiment of the present invention;

FIG. 3 is a laid out flat view of an electrode unit used in an isolator according to an embodiment of the present invention;

FIG. 4 is a side view of a top yoke component provided on an isolator according to an embodiment of the present invention;

FIG. 5 is a perspective view of an example of a spacer and a magnet provided on an isolator according to an embodiment of the present invention;

FIG. 6A is an example of a circuit diagram of a cellular phone provided with an isolator according to an embodiment of the present invention;

FIG. 6B is a diagram illustrating the operating principle of the isolator shown in FIG. 6A; and

FIG. 7 is an exploded perspective view of a conventional isolator.

### DESCRIPTION OF THE PREFERRED EMBODIMENTS

The preferred embodiments according to the present invention will now be described with reference to the drawings.

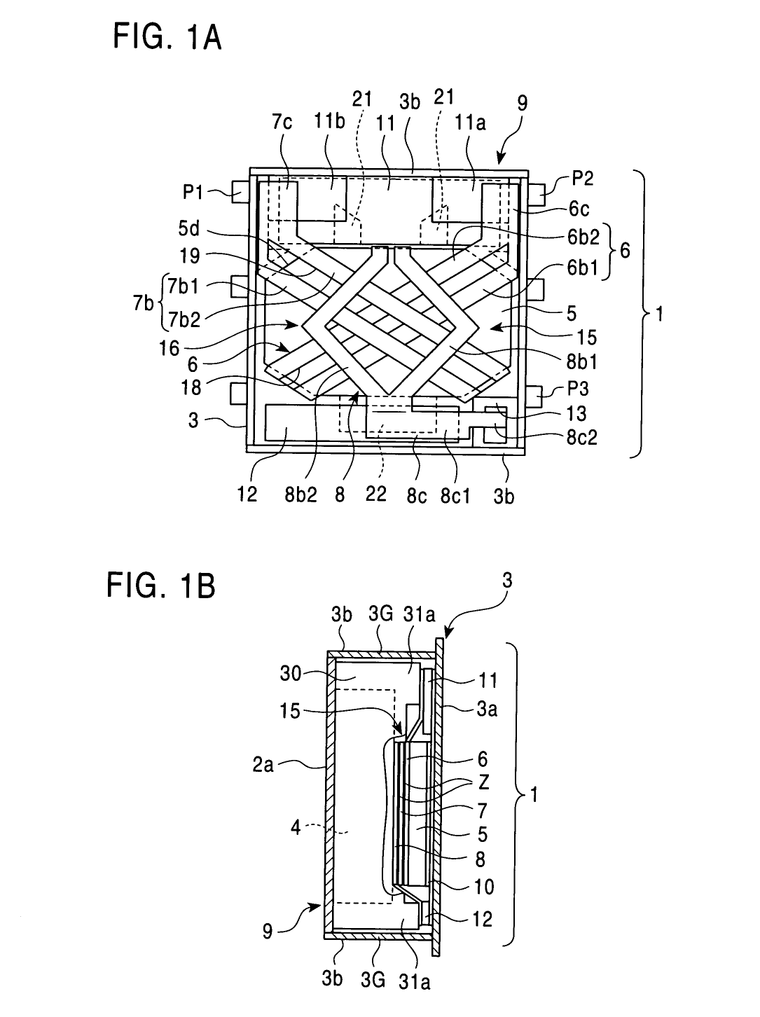

FIGS. 1A, 1B, and 2 through 5 show an isolator according to a first embodiment of the non-reciprocal circuit element of the present invention. An isolator 1 of this embodiment includes a top yoke component 2 and a bottom yoke component 3 that form a box-shaped yoke 9. The yoke 9 further includes a magnet 4 such as a permanent magnet, a magnetic plate 5 such as a ferromagnetic substance, line conductors 6, 7, and 8, a common electrode 10 that connects to the line conductors 6, 7, and 8, capacitor chips 11 and 12 disposed around the magnetic plate 5, and a terminator (resistor) 13.

The yoke 9 including the top yoke component 2 and the bottom yoke component 3 forms a thin box, for example, about 4 mm by 4 mm in plan view. The top yoke component 2, which is substantially U-shaped in side view, has dimensions appropriate for fitting into the bottom yoke component 3, which is also substantially U-shaped in side view, so that the top yoke component 2 and the bottom yoke component 3 can be joined at their openings to form an integrated single box serving as the yoke 9.

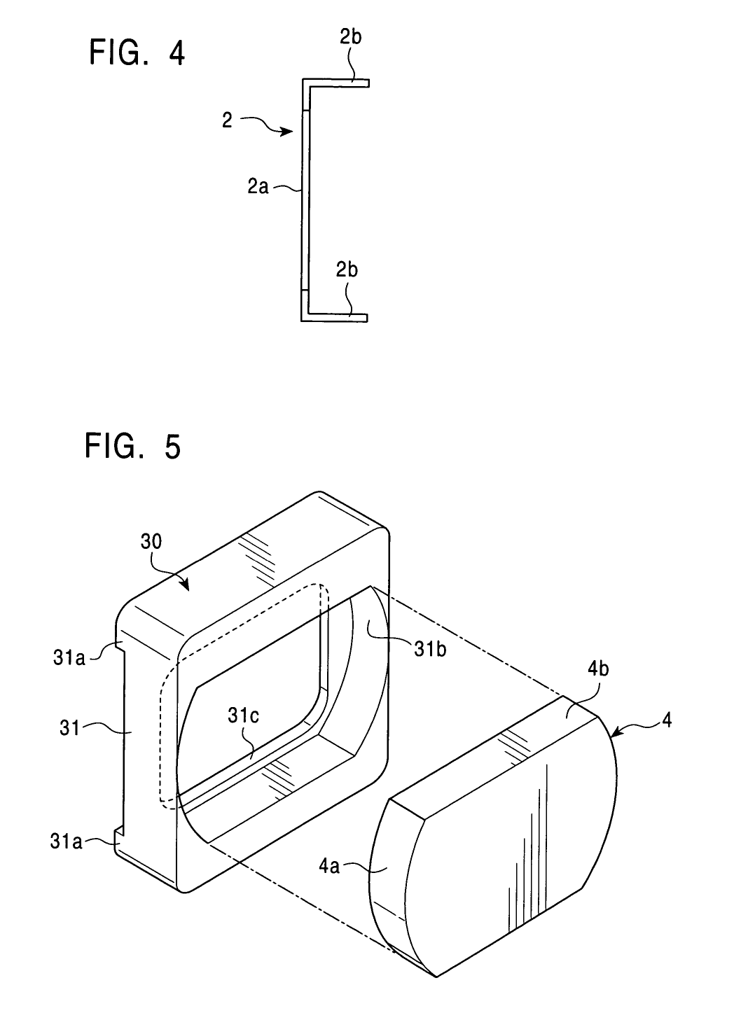

In more detail, the U-shaped bottom yoke component 3 is formed of a rectangular ferromagnetic bottom plate 3a and side plates (outer walls) 3b which stand at two opposite sides of the bottom plate 3a, as shown in FIGS. 1A and 1B. Similarly, the U-shaped top yoke component 2 is formed of a rectangular ferromagnetic top plate 2a and side plates (outer walls) 2b which stand at two opposite sides of the top plate 2a, as shown in FIGS. 1B and 4. The top yoke component 2 is engaged with the bottom yoke component 3 by alternately arranging the side plates, such as a first side plate 2b, a first side plate 3b, a second side plate 2b, and a second side plate 3b in that order, to form a low-profile box serving as the yoke 9.

The shape of the yoke components 2 and 3 is not limited to that introduced in this embodiment; the yoke components according to the present invention may have any shape that allows the yoke 9 to be formed. For example, a first yoke component may have four side plates on all edges and a second yoke component may be a flat plate. In another embodiment, a first yoke component may have side plates on three edges and a second yoke component thus has a side plate on one edge. Furthermore, in another embodiment, such side plates may not extend over the full width of an edge; minor or major part of an edge of a first and/or second yoke component may be extended and bent to form a side plate.

The space formed by integrating the top yoke component 2 and the bottom yoke component 3 as described above (inner space of the yoke 9) accommodates a magnetic assembly 15 that includes the magnetic plate 5, the three line conductors 6, 7, and 8, and the common electrode 10 that connects the conductor 6, 7, and 8.

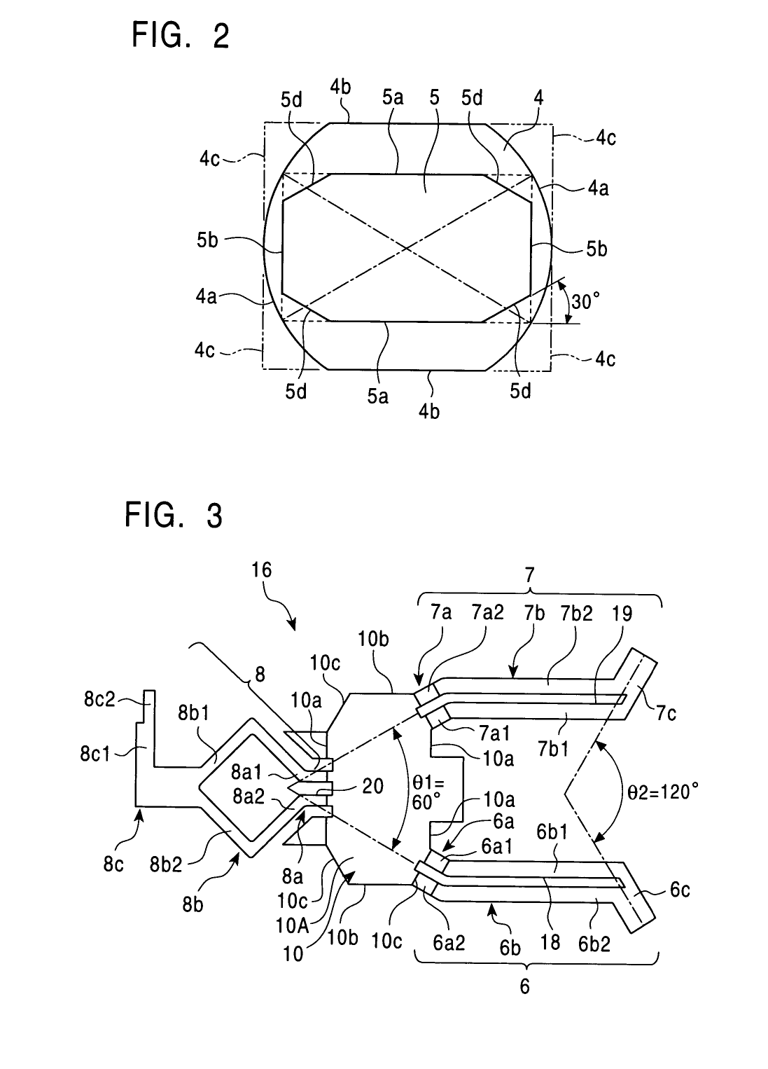

The magnetic plate 5 is composed of a ferromagnetic substance, such as a ferrite, and is substantially rectangular (with horizontal long sides) in plan view, as shown in FIG. 2. In more detail, the magnetic plate 5 is substantially rectangular with two horizontal long sides 5a facing each other, two short sides 5b perpendicular to the long sides 5a, and four oblique sides 5d that connect the long sides 5a and the short sides 5b. Thus, the major axis and the minor axis of the magnetic plate 5 are defined as the distance between the two short sides 5b (horizontal length in FIG. 2) and the distance between the two long sides 5a (vertical length in FIG. 2), respectively.

Referring to the laid out flat view in FIG. 3, the three line conductors 6, 7, and 8 and the common electrode 10 are integrated to form an electrode unit 16. The common electrode 10 includes a body 10A which is a metallic plate geometrically similar to that of the magnetic plate 5 in plan view. In plan view, the body 10A has a substantially rectangular shape with two long sides 10a, two short sides 10b, and four oblique sides 10c between the long sides 10a and the short sides 10b.

The first line conductor 6 and the second line conductor 7 extend from a first long side 10a of the body 10A. More specifically, the conductor 6 extends from a first oblique side 10c formed at one end of the first long side 10a and the conductor 7 extends from a second oblique side 10c formed at the other end of the first long side 10a. The first line conductor 6 consists of a first base segment 6a, a first main segment 6b, and a first terminal segment 6c. The second line conductor 7 consists of a second base segment 7a, a second main segment 7b, and a second terminal segment 7c.

The base segments 6a and 7a are as wide as the oblique sides 10c to smoothly extend from the oblique sides 10c. The main segments 6b and 7b are parallel to the short sides lob of the common electrode 10.

The first line conductor 6 has a slit 18 formed in the lateral center thereof so that the main segment 6b has two divisions 6b1 and 6b2. The base segment 6a also has two divisions 6a1 and 6a2. Similarly, the second line conductor 7 has a slit 19 formed in the lateral center thereof so that the main segment 7b has two divisions 7b1 and 7b2. The base segment 7a also has two divisions 7a1 and 7a2.

The common electrode 10 has the third line conductor 8 extending from the center of a second long side b1a thereof. The third line conductor 8 includes a third base segment 8a, a third main segment 8b, and a third terminal segment 8c projected from the common electrode 10.

The third base segment 8a has two strip-shaped divisions 8a1 and 8a2 separated by a slit 20 formed therebetween. The third main segment 8b has divisions 8b1 and 8b2 of L shape in plan view, and the L-shaped divisions 8b1 and 8b2 together form the main segment 8b, which is rhombic.

Furthermore, the tips of these divisions 8b1 and 8b2 are integrated into the third L-shaped terminal segment 8c. This third terminal segment 8c includes a first connection 8c1 and a second connection 8c2.

The common electrode 10 with the structure described above has the body 10A disposed on one surface (the lower surface) of the magnetic plate 5. The common electrode 10 further has the first line conductor 6, the second line conductor 7, and the third conductor 8 folded on the other surface (the upper surface) of the magnetic plate 5 and the entire common electrode 10 is mounted on the magnetic plate 5. In this manner, the common electrode 10, along with the magnetic plate 15, forms the magnetic assembly 15.

When the line conductors 6, 7, and 8 are folded and mounted on a main surface (upper surface) of the magnetic plate 5 as described above, the first conductor 6 runs along one diagonal line of the magnetic plate 5 and the second conductor 7 runs along the other diagonal line, the two conductors 6 and 7 intersecting as shown in FIG. 1A.

Although not shown in FIG. 1A, insulating sheets Z, as shown in FIG. 1B, are disposed between the magnetic plate 5 and the first line conductor 6, between the first line conductor 6 and the second line conductor 7, and between the second line conductor 7 and the third line conductor 8, so that the line conductors 6, 7, and 8 are electrically insulated from one another.

The magnetic assembly 15 is disposed in the bottom center of the bottom yoke component 3. The plate capacitor chips 11 and 12, elongated in plan view and about half as thick as the magnetic plate 5, are also disposed on the bottom yoke component 3 so as to interpose the magnetic assembly 15 therebetween. The capacitor chip 12 has the terminator 13 mounted on one end thereof.

The terminal segment 6c of the first line conductor 6 is electrically connected to a capacitor electrode 11a formed at one end of the capacitor chip 11, the terminal segment 7c of the second line conductor 7 is electrically connected to a capacitor electrode 11b formed at the other end of the capacitor chip 11, and the terminal segment 8c of the third central conductor 8 is electrically connected to the capacitor chip 12 and the terminator 13, whereby the capacitor chips 11 and 12 and the terminator 13 are connected to the magnetic assembly 15. A non-reciprocal circuit element with the structure of this embodiment functions as a circulator when the terminator 13 is disconnected.

The end of the capacitor chip 11 to which the terminal segment 7c is connected functions as a first port P1 of the isolator 1, the end of the capacitor chip 11 to which the terminal segment 6c is connected functions as a second port P2 of the isolator 1, and the end of the terminator 13 to which the terminal segment 8c is connected functions as a third port P3 of the isolator 1.

The magnetic assembly 15, when placed in the space between the bottom yoke component 3 and the top yoke component 2, occupies about half the space. Referring now to FIGS. 1B and 5, a resin spacer 30 is disposed in the space extending from the magnetic plate 5 to the top yoke component 2. The magnet 4 is also mounted on the spacer 30 disposed in the foregoing space.

The spacer 30 includes a frame 31 small enough to fit into the interior of the top yoke component 2 and legs (protrusions) 31a formed at four corners on the lower surface of the frame 31. The spacer 30 further includes a recess 31b for holding the magnet 4 on the opposite surface of the frame 31, i.e., the upper surface which is distant from the surface having the legs 31a, and a substantially rectangular hole 31c on the surface distant from the recess 31b such that the hole 31c passes through the frame 31.

Referring to FIGS. 1A and 1B, the magnetic plate 5 preferably has a horizontal length (length of the major axis extending in a longitudinal direction of the rectangular magnetic plate 5 in plan view) between 65% and 100%, and more preferably between 75% and 100%, of the width of the yoke 9. If the yoke components 2 and 3 each measure 4 mm by 4 mm in extent, the horizontal length of the magnetic plate 5 is between 2.6 mm and 4 mm for the range of 65% to 100% and between 3 mm and 4 mm for the range of 75% to 100%.

In this respect, a conventional magnetic plate that should have a horizontal length of about 50% of the width of an isolator to receive a uniform bias magnetic field, must be as small as about 2 mm in horizontal length for an isolator which measures, for example, 4 mm×4 mm. On the other hand, an isolator (denoted as an isolator 1 in this embodiment) with the structure according to the present invention can include a larger magnetic plate (with a horizontal length from 65% to 100% of the width of the isolator) without causing distortion of the bias magnetic field near the edge of the magnetic plate, thus contributing to enhanced performance of the isolator.

In general, the main segment of a line conductor disposed on the main surface of a magnetic plate preferably is at least 3 mm in length when used in an isolator for a high-frequency band, such as the 0.8 GHz band. In particular, for the magnetic plate 5 having a horizontal length of, for example, 2.67 mm, the main segment of a line conductor can easily have a length of more than 3 mm along a diagonal line of the magnetic plate 5, thus allowing a 4 mm by 4 mm isolator to be designed. In a conventional 4 mm by 4 mm isolator, on the other hand, a small magnetic plate 2 mm in width (based on about 50% of the width of the isolator) will allow the main segment disposed along a diagonal line to have a length not exceeding about 2.83 (8^{1/2}) mm.

Referring now to FIG. 2, the magnet 4 has dimensions relative to the magnetic plate 5 as shown. Specifically, the magnet 4 is shaped like a racing track in plan view, as shown in FIG. 2. This shape can be formed as follows. First, a rectangle with long sides formed by extending the two long sides 5a of the magnetic plate 5 and with short sides formed by extending the two short sides 5b of plate 5 is assumed. Then, an imaginary circle which circumscribes the rectangle is assumed. The relevant racing-track shape can be generated by partially cutting off the top and bottom of the imaginary circle. In other words, the magnet 4 has two convex surfaces (on the left and the right thereof) 4a and two flat surfaces (on the top and the bottom thereof) 4b as shown in FIG. 5. The convex surfaces 4a and flat surfaces 4b are curved lines and straight lines, respectively, in plan view, as shown in FIG. 2. It should be noted, however, that the magnet 4 may have a plan-view shape generated by partially cutting the imaginary circle along a straight line.

Referring to FIGS. 1A, 1B, 2 through 5, 6A, and 6B, the isolator 1 according to the embodiment of the present invention has the line conductors 6, 7, and 8 with their respective main segments 6b, 7b, and 8b folded at accurate angles on the upper surface of the magnetic plate 5. This structure enables signals from the input line conductor to the magnetic plate 5 to be effectively transferred to the output, demonstrating transmission characteristic with low insertion loss in a wide band. As a result, the magnetic plate 15 has superior magnetic characteristics.

Referring to FIG. 2, the magnet 4 with a racing-track shape is disposed over the substantially rectangular magnetic plate 5 to apply a bias magnetic field across the thickness of the magnetic plate 5 (vertical bias magnetic field). In this condition, the magnetic plate 5 is completely hidden by the magnet 4 in plan view, so that the entire vertical bias magnetic field effectively acts on the magnetic plate 5. The four corners of the magnetic plate 5, i.e., the oblique sides 5d are close to the edge of the magnet 4 and therefore may be subjected to a distorted bias magnetic field, as described above. To counter such a possible adverse effect, the magnet 4, as seen in plan view of FIG. 2, covers the entire magnetic plate 5 with a sufficiently wide margin from each of the oblique sides 5d to the corresponding curved surface 4a. Thus, a sufficient mass (volume) of the magnet 4 can apply a required vertical bias magnetic field around the oblique sides 5d of the magnetic plate 5. Another advantage associated with the embodiment is that the magnetic flux, which is intensified around the edge of the magnet 4, can effectively act on the magnetic plate 5 for efficient application of a bias magnetic field.

On the contrary, if the magnet 4 has a shape geometrically similar to that of the magnetic plate 5 or is substantially rectangular, only a small volume of the magnet 4 acts around the oblique sides 5d of the magnetic plate 5. This precludes a distortion-free vertical bias magnetic field with a sufficient magnitude from being generated around the oblique sides 5d of the magnetic plate 5. Even if the magnet 4 has a shape geometrically similar to that of the magnetic plate 5 or is substantially rectangular, a magnet with a width sufficiently larger than that of the magnetic plate 5 would be able to provide a distortion-free bias magnetic field around the oblique sides 5d. Such a magnet with a longer horizontal length, however, requires the yoke 9 itself to be large in the horizontal direction. This approach hence does not meet recent demands for compact isolators. When a rectangular magnet with the same horizontal length as that of the magnet 4, i.e., a rectangular magnet with the four corners indicated by double-dotted chain lines 4c in FIG. 2, is assumed, the oblique sides 5d of the magnetic plate 5 are so far away from the corners of the magnet that an intense magnetic flux existing around the edge of the magnet cannot be effectively used. This means that only a small number of fluxes effectively act upon the magnetic plate 5, precluding effective application of the bias magnetic field.

As a result of the discussions up to now, the magnet 4 preferably has a horizontal length slightly longer than that of the magnetic plate 5 and is shaped like a racing track or an ellipse similar to a racing track, so that a sufficient mass (volume) of magnet exists around the oblique sides 5d of the magnetic plate 5 and the convex surfaces 4a are located closer to the oblique sides 5d of the magnetic plate 5. For the purpose described above, various shapes such as a partially cut circle or ellipse and a polygon similar to a circle are conceivable for the convex surface 4a of the magnet 4. Referring again to FIG. 2, the major axis and the minor axis of the magnet 4 are defined as the maximum distance in parallel to the lines 4b between the two curved lines 4a and the distance between the two straight lines 4b, respectively.

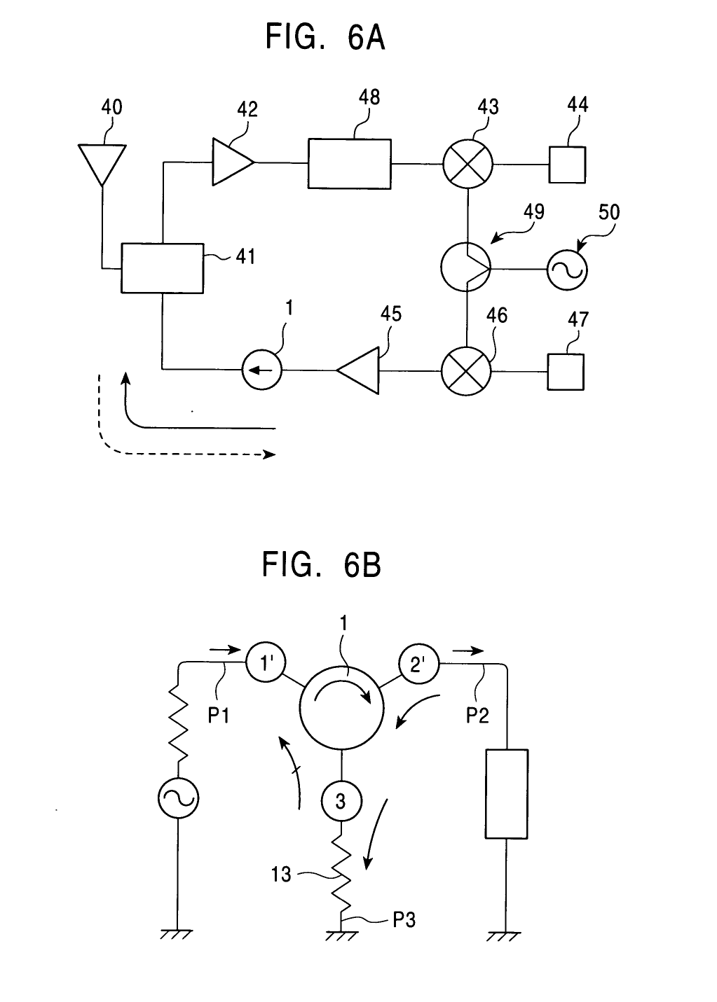

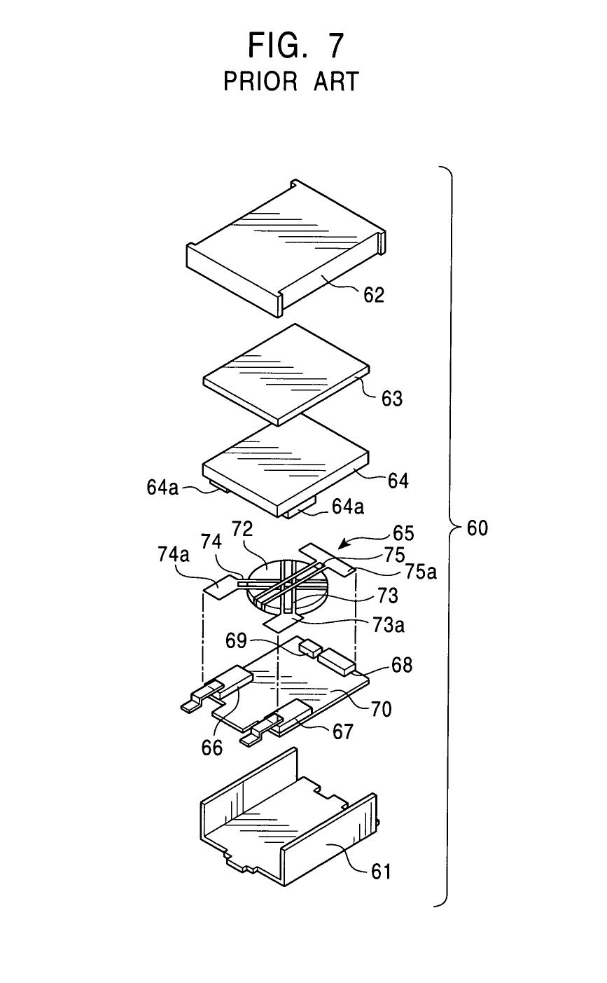

FIG. 6A is an example of circuit of a cellular phone using the isolator 1. In this circuit, a duplexer 41 is connected to an aerial 40; an IF circuit 44 is connected to an output of the duplexer 41 via a low-noise amplifier 42, an inter-stage filter 48, and a mixer 43; an IF circuit 47 is connected to an input of the duplexer 41 via the isolator 1, a power amplifier 45, and a mixer 46; and a local oscillator 50 is connected to mixers 43 and 46 via a distributing transformer 49.

Referring again to FIG. 6A, the isolator 1 described above, which is used in a circuit of a cellular phone, allows signals from the isolator 1 to the duplexer 41 to pass at low insertion loss, but causes high insertion loss with signals from the duplexer 41 to the isolator 1 to block such signals in that direction. Thus, the isolator 1 prevents undesired signals such as noise in the amplifier 45 from entering the amplifier 42 in the reverse direction.

FIG. 6B illustrates the operating principle of the isolator 1 as incorporated in the above circuit. The isolator 1 in the circuit shown in FIG. 6B passes signals from a first port P1 (denoted by symbol 1′) to a second port P2 (denoted by symbol 2′), but attenuates signals from the second port P2 (denoted by symbol 2′) to a third port P3 (denoted by symbol 3′) by absorbing the signals into the terminator 13 (resistor) to block signals from the third port P3 (denoted by symbol 3′) directly connected to the terminator 13 to the first port P1 (denoted by symbol 1′).

As described above with reference to FIG. 6B, the isolator 1 functions as a unidirectional-flow signal controller when incorporated in the circuit shown in FIG. 6A.

### EXAMPLES

For an experiment, isolators having the structure and components as shown in FIGS. 1A, 1B, and 2 through 5 were assembled. The isolators used a substantially rectangular magnetic plate as shown in FIG. 2 and magnets with a racing-track shape as shown in FIG. 2.

A capacitor chip connected to the port P1 of a first line conductor and to the port P2 of a second line conductor had a capacitance of 5.0 pF. A capacitor connected to the port 3 had a capacitance of 5.0 pF. The magnetic plate composed of ferrite had a thickness of 0.65 mm. In plan view, the magnetic plate had a horizontal length of 3.5 mm, a vertical length of 2.0 mm, and an oblique angle of 30° at the oblique sides. All magnets were shaped like a racing track based on a circular disk 4 mm in radius (denoted by “r” in Table 1 below) which was cut at the top and bottom to generate flat surfaces. In plan view, first, second, third, and fourth magnets had a vertical length of 3.8 mm, 3.6 mm, 3.4 mm, and 3.2 mm, respectively. All magnets used had a thickness of 0.65 mm.

A top yoke component and a bottom yoke component of the isolator had inner dimensions of 4 mm by 4 mm, composed of Fe or Ni—Fe alloy.

The insertion loss characteristics of magnets with the different dimensions as described above were measured. Table 1 shows the measured results.

TABLE 1

| | | Intensity of Magnetic | |
|---|---|---|---|
| Magnet Size | Thickness | Field in Magnetic Plate | Insertion Loss |
| [mm] | [mm] | [A/m] | [dB] |
| 4.0 r by 3.8 | 0.65 | 35944 | 0.45 |
| 4.0 r by 3.6 | 0.65 | 36790 | 0.44 |
| 4.0 r by 3.4 | 0.65 | 37822 | 0.42 |
| 4.0 r by 3.2 | 0.65 | 39261 | 0.42 |
| 4.0 by 3.2 (*) | 0.65 | 35288 | 0.45 |

* Substantially rectangular

The 4.0 by 3.2 (substantially rectangular) sample in Table 1 is octagonal, like the magnetic plate shown in FIG. 2, and has a horizontal length of 4.0 mm (along the long sides) and a vertical length of 3.2 mm (along the short sides) and has oblique sides at an oblique angle of 30°.

Table 1 shows that the intensity of the magnetic field in the magnetic plate increases with reduced insertion loss as the vertical length of the magnetic plates becomes smaller from 3.8 mm to 3.6 mm, 3.4 mm, and 3.2 mm. Magnets with a radius of 4.0 mm preferably have vertical lengths from 3.2 mm to 3.8 mm in order to demonstrate a more intense magnetic field and smaller insertion loss than the 4.0 by 3.2 (substantially rectangular) sample.

The ratios of the dimensions of various magnets to the dimensions of a magnetic plate are shown below, where the magnetic plate has a horizontal length of 3.5 mm and a vertical length of 2.0 mm and has oblique sides with an oblique angle of 30°: (3.2 [m] as vertical length of magnet)/(2.0 [m] as vertical length of magnetic plate)=1.6, (3.4 [m] as vertical length of magnet)/(2.0 [m] as vertical length of magnetic plate)=1.7, (3.6 [m] as vertical length of magnet)/(2.0 [m] as vertical length of magnetic plate)=1.8, (3.8 [m] as vertical length of magnet)/(2.0 [m] as vertical length of magnetic plate)=1.9. It follows from these results that the value of (vertical length of magnet)/(vertical length of magnetic plate) preferably ranges from 1.6 to 1.9.

In general, a lower rate of increase of insertion loss in an isolator suggests that the isolator exhibits less decrease in characteristics when designed to be compact. In addition, a magnet with a vertical length of much less than 3.2 mm, specifically, a length identical to that of the magnetic plate, can generate a more intense magnetic field. This approach, however, requires high-precision assembly in order to position the magnetic plate within the magnet in plan view. As a result, the magnet may not completely cover the magnetic plate and may fail to apply a vertical bias magnetic field to the entire magnetic plate, leading to high insertion loss. For this reason, it is preferable to define the value of (vertical length of magnet)/(vertical length of magnetic plate) from about 1.6 to 1.9.

What is claimed is:

1. A non-reciprocal circuit element comprising:
a yoke including, therein:
a magnetic plate;
a plurality of line conductors disposed on a main surface of the magnetic plate and insulated from one another, each line conductor having a terminal segment;
a plurality of capacitor chips disposed around the magnetic plate; and
a magnet for applying a DC bias magnetic field in a direction substantially perpendicular to the main surface of the magnetic plate,
wherein the line conductors intersect on a main surface of the magnetic plate and are connected to one another on the other main surface of the magnetic plate, the terminal segments of the line conductors are connected to the capacitor chips, and the magnet has a major axis and a minor axis in plan view and has a convex surface on at least one peripheral portion thereof.

2. The non-reciprocal circuit element according to claim 1, wherein the magnet has a plan-view shape generated by partially cutting a circle or an ellipse along a straight line.

3. The non-reciprocal circuit element according to claim 1, wherein the magnet has an elliptic shape in plan view.

4. The non-reciprocal circuit element according to claim 2, wherein the magnet has a plan-view shape of a racing track.

5. The non-reciprocal circuit element according to claim 1, wherein a projection plane of the magnetic plate is identical to or completely disposed within a projection plane of the magnet.

6. The non-reciprocal circuit element according to claim 1, wherein the ratio of the minor axis of the magnet to the minor axis of the magnetic plate or the ratio of the major axis of the magnet to the major axis of the magnetic plate ranges from 1.0 to 1.9.

7. The non-reciprocal circuit element according to claim 6, wherein the ratio of the minor axis of the magnet to the minor axis of the magnetic plate or the ratio of the major axis of the magnet to the major axis of the magnetic plate ranges from 1.6 to 1.9.
